(19) United States
(12) Patent Application Publication
(10) Pub. No.: US 2015/0095586 A1
(43) Pub. Date: Apr. 2, 2015

(54) STORING NON-TEMPORAL CACHE DATA

(71) Applicant: ADVANCED MICRO DEVICES , INC., Sunnyvale, CA (US)

(72) Inventors: William L Walker, Fort Collins, CO (US); Robert Krick, Longmont, CO (US)

(73) Assignee: ADVANCED MICRO DEVICES , INC., Sunnyvale, CA (US)

(21) Appl. No.: 14/042,474

(22) Filed: Sep. 30, 2013

(51) Int. Cl. G06F 12/12

(52) U.S. Cl. CPC G06F 12/122
USPC 711/136

(57) ABSTRACT

Embodiments herein provide for using one or more cache memory to facilitate non-temporal transaction. A request to store data into a cache associated with a processor is received. In response to receiving the request, a determination is made as to whether the data to be stored is non-temporal data. A predetermined location of the cache is selected; the location to which storing of the non-temporal data is restricted to a predetermined location, in response to determining the data to be stored is non-temporal data. The non-temporal data is data that is not accessed within a predetermined period of time. The non-temporal data is stored into the predetermined location.

### BACKGROUND OF THE INVENTION

1. Technical Field

Generally, the disclosed embodiments relate to integrated circuits, and, more particularly, to managing non-temporal data stored in cache.

2. Description of the Related Art

Many processing devices utilize caches to reduce the average time required to access information stored in a memory. A cache is a smaller and faster memory that stores copies of instructions or data that are expected to be used relatively frequently. For example, central processing units (CPUs) are generally associated with a cache or a hierarchy of cache memory elements. Other processors, such as graphics processing units or accelerated processing units, can also implement cache systems. Instructions or data that are expected to be used by the CPU are moved from (relatively large and slow) main memory into the cache. When the CPU needs to read or write a location in the main memory, it first checks to see whether a copy of the desired memory location is included in the cache memory. If this location is included in the cache (a cache hit), then the CPU can perform the read or write operation on the copy in the cache memory location. If this location is not included in the cache (a cache miss), then the CPU needs to access the information stored in the main memory and, in some cases, the information can be copied from the main memory and added to the cache. Proper configuration and operation of the cache can reduce the average latency of memory accesses to a value below the main memory latency and close to the cache access latency.

Most data that are stored in cache tend to be of a temporal nature. Temporal data generally exhibits temporal locality, that is, temporal data is generally likely to be used again in relative temporal proximity. Other times, non-temporal data is used by a process. For example when a process reads a memory location then a short while later reads the same memory location again, the data at that memory location is considered temporal. In one example, temporal data may refer to data that is accessed a threshold number of times or less within a predetermined period of time. Non-temporal, or transient data, generally refers to data that will generally be used only once in temporal proximity. For example when a process is copying a range of memory from one location to another, it reads from the old location and writes to the new location. In some example, the process may not read the old location for a significant amount of time. In these situations the data in the old location may be considered non-temporal. In some examples, the term non-temporal data may refer to data that is not accessed within a predetermined period of time. Designers often deal with non-temporal transactions by using non-temporal data without installing into any level of cache. This approach is taken to avoid cache pollution, which refers to the state wherein non-temporal data interferes with the usage of temporal data in the cache. In instances where it would be advantageous to use cache storage for non-temporal data, designers allocate the non-temporal data to one level of cache. However, if the next level of cache is inclusive of the previous level, then the non-temporal data would also be allocated to the next level cache, thereby resulting in cache pollution.

### SUMMARY OF EMBODIMENTS

The following presents a simplified summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

The apparatuses, systems, and methods in accordance with the embodiments disclosed herein may facilitate providing for using one or more cache memory to facilitate non-temporal transaction. Some embodiments may provide a method that includes a request to store data into a cache associated with a processor is received. In response to receiving the request, a determination is made as to whether the data to be stored is non-temporal data. A predetermined location of the cache is selected; the location to which storing of the non-temporal data is restricted to a predetermined location, in response to determining the data to be stored is non-temporal data. The non-temporal data is data that is not accessed within a predetermined period of time. The non-temporal data is stored into the predetermined location.

Some embodiments may include a method that includes receiving a request to store data into a cache of a processor and determining, in response to receiving the request, whether the data to be stored is non-temporal data. The method may also include selecting, in response to a determination that the data to be stored is non-temporal data, a location of the cache based upon a value of at least one Least Recently Used (LRU) bit associated with the cache, for storing the non-temporal data; storing the non-temporal data into the selected location of the cache; and retaining the value of the at least one LRU bit upon storing the data into the selected location.

Some embodiments provide an integrated circuit that includes at least a first compute unit. The first compute unit is configured to provide a request to store first data into a cache of the processor. The integrated circuit may also include a cache control unit configured to receive an indication that the first data is non-temporal data in response to the request to store first data and select a first predetermined location in the cache to which storage of the first data is restricted. The non-temporal data is data that is not accessed within a predetermined period of time.

Some embodiments provide a non-transitory computer-readable medium storing instructions executable by at least one processor for to fabricating an integrated circuit device. The integrated circuit device is capable of using one or more cache memory to facilitate non-temporal transaction. The integrated circuit device includes at least a first compute unit. The first compute unit is configured to provide a request to store first data into a cache of the processor. The integrated circuit device also includes a cache control unit configured to receive an indication that the first data is non-temporal data in response to the request to store first data, the cache control unit further configured to select a first predetermined location in the cache to which storage of the first data is restricted.

### BRIEF DESCRIPTION OF THE FIGURES

The disclosed subject matter will hereafter be described with reference to the accompanying drawings, wherein like reference numerals denote like elements, and:

FIG. 1 is a schematic diagram of an exemplary microcircuit design in accordance with some embodiments.

FIG. 2 provides a representation of a CPU, depicted in FIG. 1, in accordance with some embodiments. (needs label in Drawings file)

FIG. 3 provides a representation of a processor depicted in FIG. 1, in accordance with some embodiments.

FIG. 4A provides a representation of a silicon die/chip that includes one or more circuits as shown in FIG. 3, in accordance with some embodiments.

FIG. 4B provides a representation of a silicon wafer which includes one or more dies/chips that may be produced in a fabrication facility, in accordance with some embodiments.

FIG. 5 is a flowchart of a method relating to storing non-temporal data into cache, in accordance with some embodiments.

FIG. 6 is a flowchart another method relating to storing non-temporal data into cache, in accordance with some embodiments.

While the disclosed subject matter is susceptible to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the spirit and scope of the disclosed subject matter as defined by the appended claims.

### DETAILED DESCRIPTION

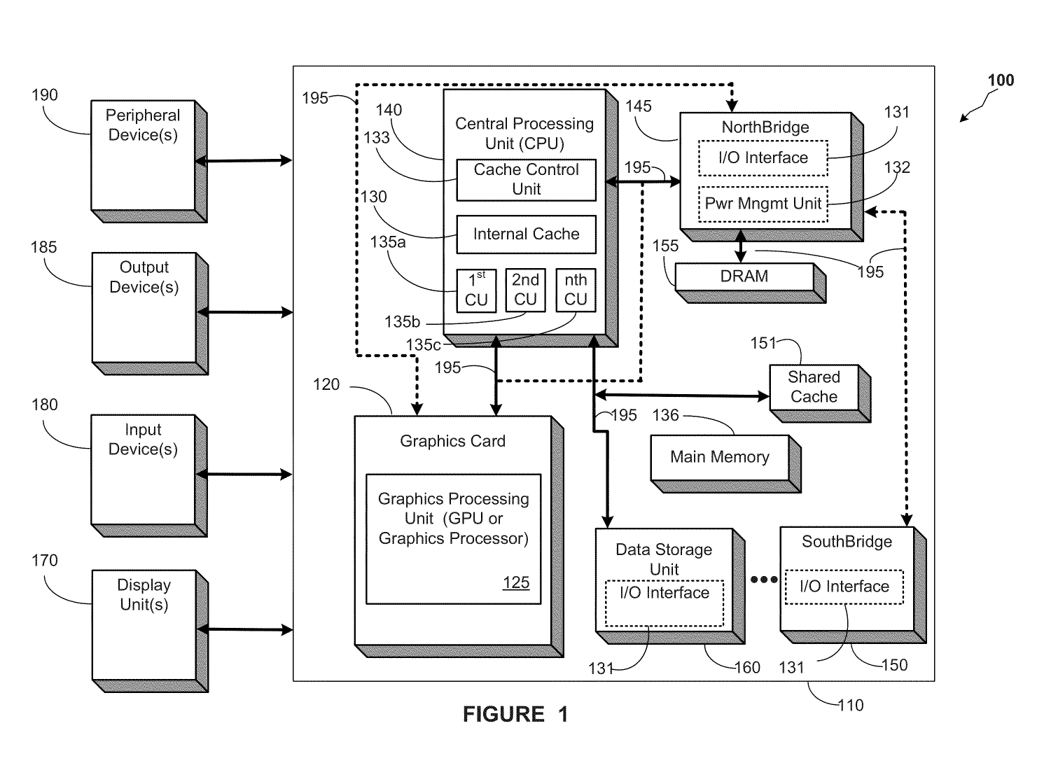

Turning now to FIG. 1, a block diagram representation of a computer system 100 comprising a processor 110, in accordance with some embodiments, is illustrated. Modern computer systems may exist in a variety of forms, such as telephones, tablet computers, desktop computers, laptop computers, servers, smart televisions, or other consumer electronic devices. The processor unit 110 may comprise one or more central processing units (CPUs) 140, each of which may comprise various compute units (CUs) 135, e.g. first CU 135a, second CU 135b, through N^{th} CU 135c). Each of the CPUs 140 may also comprise an internal cache 130 that provides a shared resource (in this case, cache memory) for the CUs 135. The CPUs 140 may also comprise a cache control unit 133 to control the temporal and non-temporal transactions in accordance with embodiments herein. The processor unit 110 may also comprise a main memory 136, which may be used by the CPU 140 to retrieve various data for operations. The main memory 136 may also interface with the internal cache 130 and the shared cache 151. The processor unit 110 may also comprise a shared cache 151 of memory resources shared among the various CPUs 140, compute units 135 of one or more CPUs 140, and/or graphics processing units (GPUs) 125 of a graphics card 120.

The computer system 100 may also comprise a northbridge 145. Among its various components, the northbridge 145 may comprise a power management unit (PMU) 132 that may regulate the amount of power consumed by the compute units 135, internal cache 130, CPUs 140, GPUs 125, and/or the SCU 152. Particularly, in response to changes in demand for the compute units 135, CPUs 140, and/or GPUs 125, the PMU 132 may request each of the plurality of compute units 135, internal cache 130, CPUs 140, shared cache 151, and/or GPUs 125 to enter a low power state, exit the low power state, enter a normal power state, or exit the normal power state.

The computer system 100 may also comprise a DRAM 155. The DRAM 155 may be configured to store one or more states of one or more components of the computer system 100. Particularly, the DRAM 155 may be configured to store one or more states of the compute units 135, the internal cache 130, the shared cache 151, one or more CPUs 140, and/or one or more GPUs 125.

The computer system 100 may as a routine matter comprise other known units and/or components, e.g., one or more I/O interfaces 131, a southbridge 150, a data storage unit 160, display unit(s) 170, input device(s) 180, output device(s) 185, and/or peripheral devices 190, among others.

The computer system 100 may also comprise one or more data channels 195 for communication between one or more of the components described above.

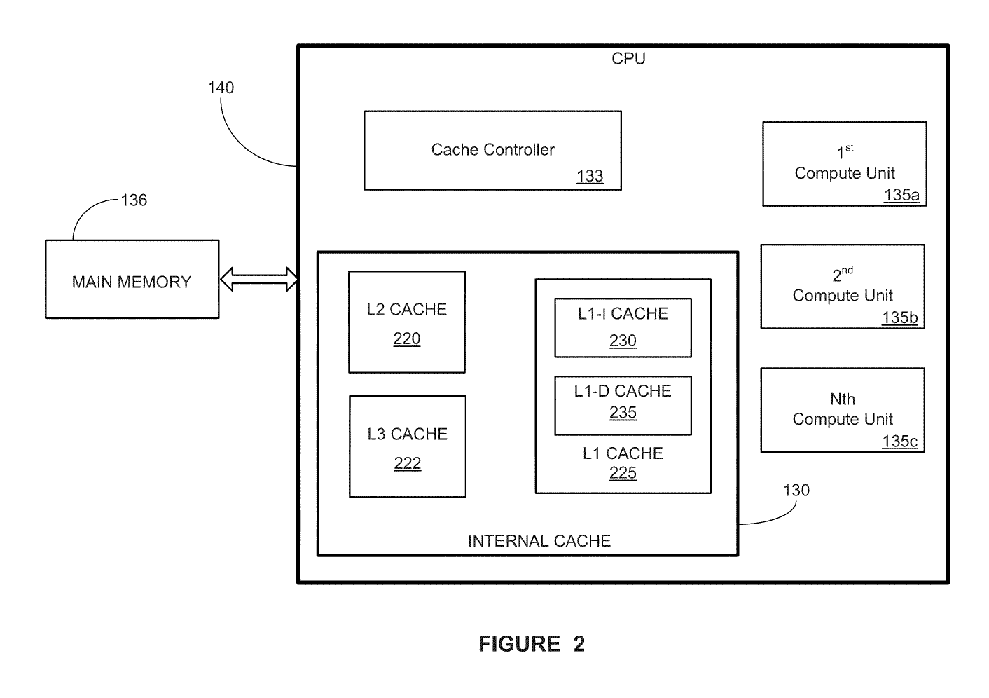

Turning now to FIG. 2, a block diagram representation of the CPU 140, in accordance with some embodiments, is illustrated. The CPU 140 may is configured to access instructions or data that are stored in the main memory 136. In the illustrated embodiment, the CPU 140, which includes the 1^{st} through Nth compute units 135a-c that are used to execute the instructions or manipulate the data. The CPU 140 may also implements a hierarchical (or multilevel) cache system that is used to speed access to the instructions or data by storing selected instructions or data in the caches. However, persons of ordinary skill in the art having benefit of the present disclosure should appreciate that alternative embodiments may implement different configurations of the CPU 140, such as configurations that use external caches, e.g., shared cache 151. Moreover, the techniques described in the present application may be applied to other processors such as graphical processing units (GPUs), accelerated processing units (APUs), and the like.

The illustrated cache system includes a level 2 (L2) cache 120 for storing copies of instructions or data that are stored in the main memory 136. In the illustrated embodiment, the L2 cache 220 is 16-way associative to the main memory 136 so that each line in the main memory 136 can potentially be copied to and from 16 particular lines (which are conventionally referred to as “ways”) in the L2 cache 220. However, persons of ordinary skill in the art having benefit of the present disclosure should appreciate that alternative embodiments of the main memory 136 or the L2 cache 220 can be implemented using any associativity. Relative to the main memory 136, the L2 cache 220 may be implemented using smaller and faster memory elements. The L2 cache 220 may also be deployed logically or physically closer to the compute units 135a-c (relative to the main memory 136) so that information may be exchanged between the compute units 135a-c and the L2 cache 220 more rapidly or with less latency.

The illustrated cache system also includes an L1 cache 225 for storing copies of instructions or data that are stored in the main memory 136 or the L2 cache 220. Relative to the L2 cache 220, the L1 cache 225 may be implemented using smaller and faster memory elements so that information stored in the lines of the L1 cache 225 can be retrieved quickly by the CPU 140. The L1 cache 225 may also be deployed logically or physically closer to the CPU core 115 (relative to the main memory 136 and the L2 cache 220) so that information may be exchanged between the CPU core 115 and the L1 cache 225 more rapidly or with less latency (relative to communication with the main memory 136 and the L2 cache 220). Persons of ordinary skill in the art having benefit of the present disclosure should appreciate that the L1 cache 225 and the L2 cache 220 represent one exemplary embodiment of a multi-level hierarchical cache memory system. Alternative embodiments may use different multilevel caches including elements such as L0 caches, L1 caches, L2 caches 220, L3 caches 222, and the like. In some embodiments, caches farther from the processor may be inclusive of one or more caches nearer to the processor so that lines in the nearer caches are also stored in the inclusive farther cache(s). Caches are typically implemented in static random access memory (SRAM), but may also be implemented in other types of memory such as dynamic random access memory (DRAM).

In the illustrated embodiment, the L1 cache 225 is separated into level 1 (L1) caches for storing instructions and data, which are referred to as the L1-I cache 230 and the L1-D cache 235. Separating or partitioning the L1 cache 225 into an L1-I cache 230 for storing instructions and an L1-D cache 235 for storing data may allow these caches to be deployed closer to the entities that are likely to request instructions or data, respectively. Consequently, this arrangement may reduce contention, wire delays, and generally decrease latency associated with instructions and data. In one embodiment, a replacement algorithm dictates that the lines in the L1-I cache 230 are replaced with instructions from the L2 cache 220 and the lines in the L1-D cache 235 are replaced with data from the L2 cache 220. However, persons of ordinary skill in the art should appreciate that an alternative embodiment of the L1 cache 225 may not be partitioned into separate instruction-only and data-only caches 230, 235.

The cache control unit 133 may comprise a replacement algorithm that is capable of controlling data flow to and the internal and/or shared cache 130, 151. Although descriptions herein generally refer to the internal cache 130 for ease of illustration, those skilled in the art should appreciate that the concepts described herein also apply to interactions with the shared cache 151. When data is to be written into the internal cache 130, the replacement algorithm may direct the data based upon the Least Recently Used (LRU) bits of the cache. With regard to writing non-temporal data into the internal cache 130, in some embodiments, the replacement algorithm may be overridden and the non-temporal data may be written into a predetermined way of the internal cache 130.

The cache control unit 133 may include a predetermined arrangement for directing non-temporal data to specific location in the cache. For example, non-temporal data may be directed to way 15 in the L1 cache 225, which such data may be directed to way 7 of the L2 cache 220. Some embodiments limit the non-temporal data to only of the ways (e.g., way 15) of the internal cache 130. The predetermined way may be selected such that a large amount of non-temporal data would not excessively pollute the overall cache memory.

Other embodiments provide the cache control unit 133 to direct the storing of non-temporal data into the internal cache 130 in a normal fashion, while not updating the LRU bits of the cache. In this manner, the non-temporal data may be overwritten during the next write to the internal cache 130, thereby reducing cache pollution. In one embodiment, the cache control unit 133 may be capable of associating a marker to the non-temporal data, identifying the data is non-temporal data. Other embodiments provide for the cache control unit 133 to detect a marker into the non-temporal data identifying the data as being non-temporal data. For example, if non-temporal data stored in L2 cache 220 is victimized, instead of moving the victimized data into L3 cache 222, which may have been the normal protocol, the non-temporal data would be discarded, thereby reducing cache pollution.

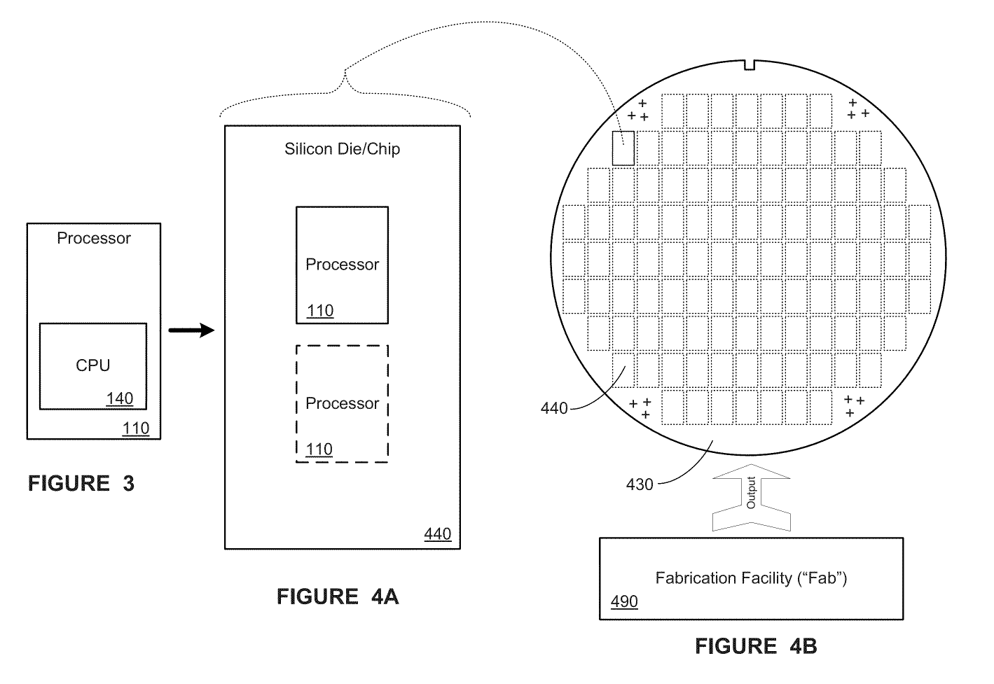

Turning now to FIG. 3 and FIG. 4A, in some embodiments, the processor unit 110 comprising a CPU 140 may reside on a silicon die/chip 440. The silicon die/chip 440 may be housed on a motherboard or other structure of the computer system 100. In some embodiments, there may be more than one processor unit 110 on each silicon die/chip 440. Some embodiments of the processor unit 110 may be used in a wide variety of electronic devices.

Turning now to FIG. 4B, in accordance with some embodiments, and as described above, the processor unit 110 may be included on the silicon chip/die 440. The silicon chip/die 440 may contain one or more different configurations of the processor unit 110. The silicon chip/die 440 may be produced on a silicon wafer 430 in a fabrication facility (or “fab”) 490. That is, the silicon wafer 430 and the silicon die/chip 340 may be referred to as the output, or product of, the fab 490. The silicon chip/die 440 may be used in electronic devices.

The circuits described herein may be formed on a semiconductor material by any known means in the art. Forming may be done, for example, by growing or deposition, or by any other means known in the art. Different kinds of hardware descriptive languages (HDL) may be used in the process of designing and manufacturing the microcircuit devices. Examples include VHDL and Verilog/Verilog-XL. In some embodiments, the HDL code (e.g., register transfer level (RTL) code/data) may be used to generate GDS data, GDSII data and the like. GDSII data, for example, is a descriptive file format and may be used in some embodiments to represent a three-dimensional model of a semiconductor product or device. Such models may be used by semiconductor manufacturing facilities to create semiconductor products and/or devices. The GDSII data may be stored as a database or other program storage structure. This data may also be stored on a computer readable storage device (e.g., data storage units, RAMs, compact discs, DVDs, solid state storage and the like) and, in some embodiments, may be used to configure a manufacturing facility (e.g., through the use of mask works) to create devices capable of embodying various aspects of some embodiments. As understood by one or ordinary skill in the art, this data may be programmed into a computer, processor, or controller, which may then control, in whole or part, the operation of a semiconductor manufacturing facility (or fab) to create semiconductor products and devices. In other words, some embodiments relate to a non-transitory computer-readable medium storing instructions executable by at least one processor to fabricate an integrated circuit. These tools may be used to construct the embodiments described herein.

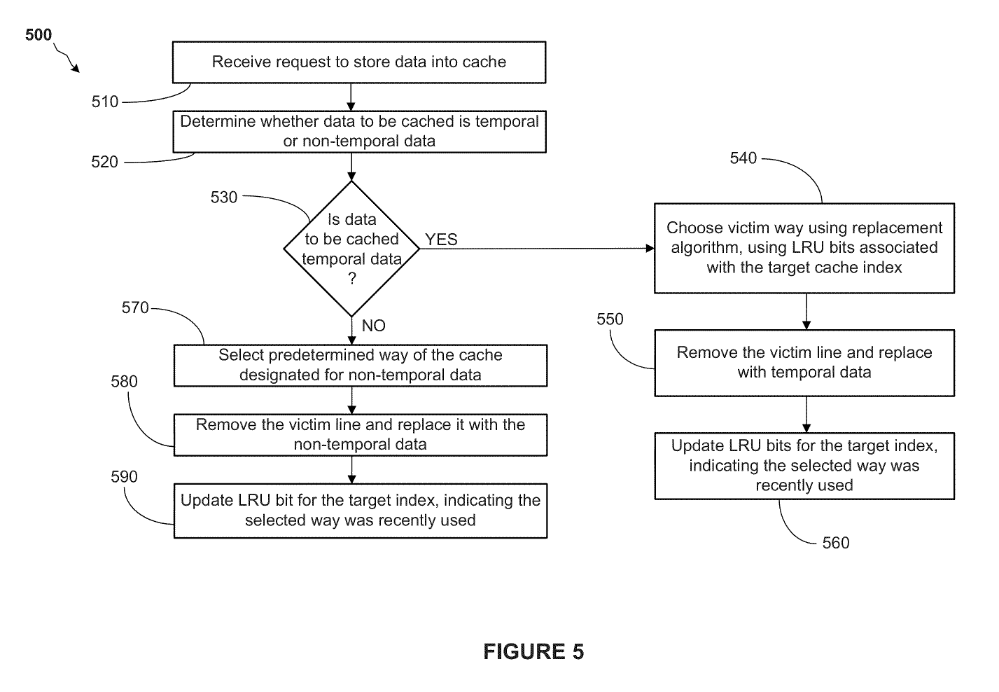

FIG. 5 presents a flowchart depicting a method 500 according to some embodiments. As illustrated in FIG. 5, the method 500 may comprise: receiving a request to store data into cache memory (at 510). The cache control unit 133 may respond by controlling the writing of data into the internal cache 130. A determination may be made as to whether the data to be cached is temporal data or non-temporal data (at 520). In one embodiment, such a determination may be made by software and communicated to the hardware using a special instruction type or memory type that indicates the non-temporal nature of the data involved. In alternative embodiments, the determination may also be made by hardware, by observing behavior patterns of instruction sequences over time and determining that certain memory locations are not used multiple times. Temporal data generally exhibits temporal locality, that is, temporal data is generally likely to be used again in relative temporal proximity. Other times, non-temporal data is used by a process. For example when a process reads a memory location then a short while later reads the same memory location again, the data at that memory location is considered temporal. In one example, temporal data may refer to data that is accessed a threshold number of times or less within a predetermined period of time. Non-temporal, or transient data, generally refers to data that will generally be used only once in temporal proximity. For example when a process is copying a range of memory from one location to another, it reads from the old location and writes to the new location. In some example, the process may not read the old location for a significant amount of time. In these situations the data in the old location may be considered non-temporal. In some examples, the term non-temporal data may refer to data that is not accessed within a predetermined period of time. In response to a determination (at 530) the data to be cached is temporal data, the cache control unit 133 may select a victim way using a replacement algorithm (at 540). The selection of the victim way, in which to write the temporal data, may be performed using the LRU bits associated with the target cache index. The cache control unit 133 may then remove the victim line/way and replace that line/way with the temporal data (at 550). Once the temporal data has been entered into the victim line/way, the LRU bits of the target index are updated (at 560), indicating that the selected way was recently used. In some alternative embodiments, a hybrid scheme may be employed, wherein a single way may be used and the LRU bits of the target index are not updated. In yet other embodiments, data may be marked as non-temporal by tagging the data as such (e.g., in the LRU bits), and this indication may be used to select a victim for a subsequent non-temporal request, instead of using a dedicated way.

When a determination is made that the data to be cached is not temporal data (at 530), i.e., the data to be cached is non-temporal data, the predetermined way (e.g., way 15 of the L1 cache 225) of the target cache is selected (at 570). In some embodiments, step 570, which includes selecting the predetermined way designated for non-temporal data, entails overriding the operation of the replacement algorithm. The victim line/way is cleared and replaced with the non-temporal data (at 580). The LRU bits for the index of the target cache is updated (at 590), indicating that the selected way was recently used.

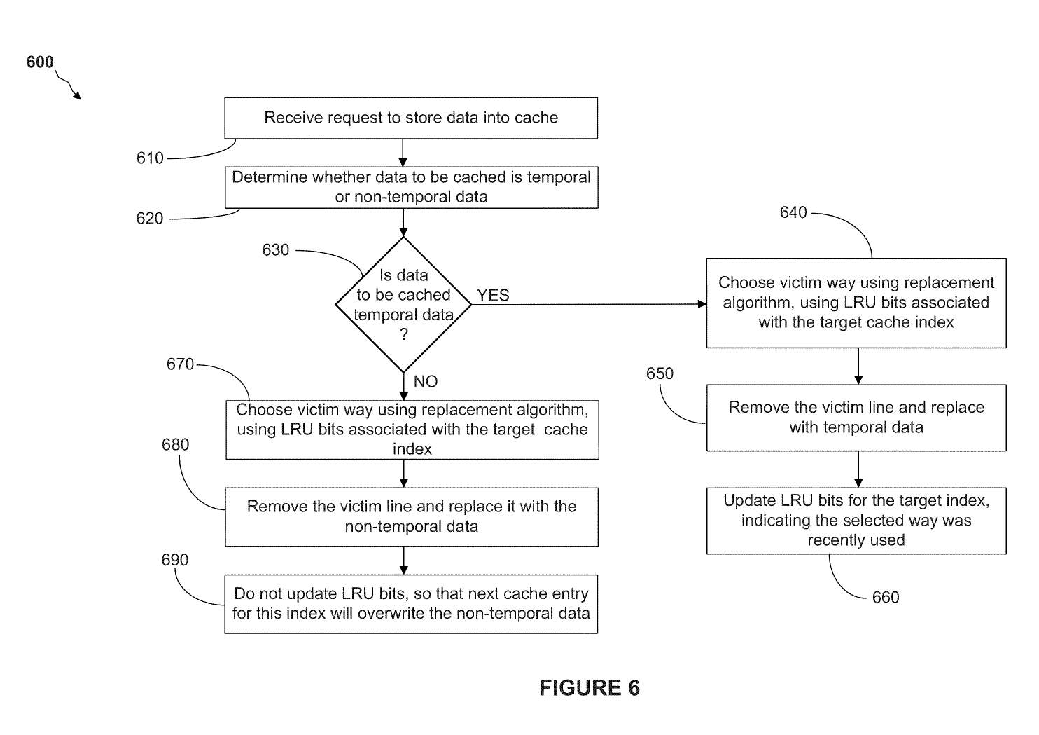

FIG. 6 presents a flowchart depicting a method 600 according to some embodiments. As illustrated in FIG. 6, the method 600 may comprise: receiving a request to store data into cache memory (at 610). The cache control unit 133 may respond by controlling the writing of data into the internal cache 130. A determination may be made as to whether the data to be cached is temporal data or non-temporal data (at 620). In response to a determination (at 630) the data to be cached is temporal data, the cache control unit 133 may select a victim way using a replacement algorithm (at 640). The selection of the victim way, in which to write the temporal data, may be performed using the LRU bits associated with the target cache index. The cache control unit 133 may then remove the victim line/way and replace that line/way with the temporal data (at 650). Once the temporal data has been entered into the victim line/way, the LRU bits of the target index are updated (at 660), indicating that the selected way was recently used.

When a determination is made that the data to be cached is not temporal data (at 630), i.e., the data to be cached is non-temporal data, cache control unit 133 may select a victim way using a replacement algorithm or a cache controller (at 670). The selection of the victim way, in which to write the non-temporal data, may be performed using the LRU bits associated with the target cache index. The cache control unit 133 may then remove the victim line/way and replace that line/way with the non-temporal data (at 680). Once the non-temporal data has been entered into the victim line/way, the LRU bits of the target index are not updated (at 690), contrary to normal protocol when a victim line is replaced. Thus, once the non-temporal data is written onto the victim line, the LRU bits are not updated in order to ensure that the next instance when the cache is targeted, the same line/way is overwritten, thereby eliminating the non-temporal data.

In the case where a plurality of compute units 135a-c share the internal cache 130 (or the shared cache 151, a separate predetermined way may be designated for each corresponding compute units 135a-c. For example, for non-temporal data relating to the 1^{st} compute unit 135a, the predetermined way may be designated as way 13 of the L1 cache 225. For non-temporal data relating to the 2^{nd} compute unit 135b, the predetermined way may be designated as way 14 of the L1 cache 225. Likewise, for non-temporal data relating to the N^{th} compute unit 135c, the predetermined way may be designated as way 15 of the L1 cache 225.

The methods illustrated in FIGS. 5 and 6 may be governed by instructions that are stored in a non-temporal computer readable storage medium and that are executed by at least one processor of the computer system 100. Each of the operations shown in FIGS. 5-6 may correspond to instructions stored in a non-temporal computer memory or computer readable storage medium. In various embodiments, the non-temporal computer readable storage medium includes a magnetic or optical disk storage device, solid state storage devices such as Flash memory, or other non-volatile memory device or devices. The computer readable instructions stored on the non-temporal computer readable storage medium may be in source code, assembly language code, object code, or other instruction format that is interpreted and/or executable by one or more processors.

Embodiments provide for using one or more cache memory to facilitate non-temporal transaction. One or more predetermined ways for a cache may be designated for non-temporal data. The predetermined way(s) may be selected such that a large amount of non-temporal data would not excessively pollute the overall cache memory. Other embodiments provide for storing non-temporal data into a cache in a normal fashion, while not updating the Least Recently Used (LRU) bits of the cache. In this manner, the non-temporal data may be overwritten during the next write to the cache. Other embodiments provide for entering a marker into the non-temporal data identifying the data as non-temporal. In this manner, if the non-temporal data is victimized in one cache, instead of moving the victimized data into another cache, the non-temporal data may be discarded. In one embodiment, the phrase “data being restricted” as used herein may refer to the data being restricted to a predetermined location. In one embodiment, the term “data being restricted” may refer to data being allowed to be stored in one location and not allowed to be stored in other locations.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the disclosed subject matter. Accordingly, the protection sought herein is as set forth in the claims below.

What is claimed:

1. A method, comprising:
receiving a request to store data into a cache associated with a processor;
determining, in response to receiving said request, whether said data to be stored is non-temporal data;
in response to determining said data to be stored is non-temporal data, selecting a predetermined location of said cache, said location to which storing of said non-temporal data is restricted to a predetermined location, wherein said non-temporal data is data that is not accessed within a predetermined period of time; and
storing said non-temporal data into said predetermined location.

2. The method of claim 1, wherein said non-temporal data is transient data.

3. The method of claim 1, further comprising updating at least one Least Recently Used (LRU) bit associated with said cache in response to storing said non-temporal data.

4. The method of claim 3, further comprising using the indication of said LRU bit identifying said data as non-temporal data and selecting a victim for a subsequent non-temporal request.

5. The method of claim 1, further comprising selecting a location of said cache for storing said data, in response to an indication from a replacement algorithm, in response to a determination that said data is not non-temporal data, said indication from said replacement algorithm being based upon at least one Least Recently Used (LRU) bit associated with said cache.

6. The method of claim 1, wherein selecting said predetermined location of said cache comprises overriding a directive from a replacement algorithm to store the non-temporal data into a location in the cache.

7. The method of claim 1, wherein selecting said predetermined location of said cache comprises preselecting a way associated with said cache

8. The method of claim 6, wherein preselecting a way associated with said cache comprises preselecting the last way number of an L1 cache and the last way number of an L2 cache.

9. The method of claim 1, wherein selecting said predetermined location of said cache comprises preselecting a first way for a first compute unit of said processor and preselecting a second way for a second compute unit of said processor.

10. The method of claim 1, further comprising:
receiving a request to store second data into said first cache of said processor;
determining, in response to receiving said request to store second data, whether said second data is non-temporal data;
selecting, in response to a determination that said second data is non-temporal data, a second predetermined location of said first cache for storing said second data; and
storing said second data into said second predetermined location.

11. A method, comprising:
receiving a request to store data into a cache of a processor;
determining, in response to receiving said request, whether said data to be stored is non-temporal data;
selecting, in response to a determination that said data to be stored is non-temporal data, a location of said cache based upon a value of at least one Least Recently Used (LRU) bit associated with said cache, for storing said non-temporal data;
storing said non-temporal data into the selected location of said cache; and
retaining said value of said at least one LRU bit upon storing said data into said selected location.

12. The method of claim 11, further comprising storing subsequent data into said location of said cache, based upon said at least one LRU bit.

13. The method of claim 11, further comprising:
selecting a location of said cache based upon at least one Least Recently Used (LRU) bit associated with said cache, in response to a determination that said data to be stored is temporal data;
storing said temporal data into the selected location of said cache; and
updating said value of said at least one LRU bit upon storing said temporal data into said selected location.

14. The method of claim 11, further comprising modifying at least one bit of said non-temporal data identifying the non-temporal nature of the non-temporal data.

15. An integrated circuit device, comprising:
at least a first compute unit, wherein said first compute unit is configured to provide a request to store first data into a cache of said processor; and
a cache control unit configured to receive an indication that said first data is non-temporal data in response to said request to store first data and select a first predetermined location in said cache to which storage of the first data is restricted, wherein said non-temporal data is data that is not accessed within a predetermined period of time.

16. The integrated circuit device of claim 15, wherein said non-temporal data is transient data.

17. The integrated circuit device of claim 15, further comprising:
a second compute unit, wherein said second compute unit is configured to provide a request to store second data into cache of said processor; and
wherein said cache control unit is further configured to receive an indication that said second data is non-temporal data in response to said request to store said second data, said cache control unit further configured to select a second predetermined location in said cache to which storage of the second data is restricted

18. The integrated circuit device of claim 17, wherein said cache control unit comprises a replacement algorithm for updating a Least Recently Used (LRU) bit associated with said cache upon storing at least one of said first data or said second data.

19. The integrated circuit device of claim 15, wherein said first location is a first way of said cache, and said second predetermined location is a second way of said cache.

20. A non-transitory computer-readable medium storing instructions executable by at least one processor to fabricate an integrated circuit device, wherein the integrated circuit device comprises:
at least a first compute unit, wherein said first compute unit is configured to provide a request to store first data into a cache of said processor; and
a cache control unit configured to receive an indication that said first data is non-temporal data in response to said request to store first data, said cache control unit further configured to select a first predetermined location in said cache to which storage of the first data is restricted.

21. The non-transitory computer-readable medium of claim 20, wherein said integrated circuit device further comprises:
a second compute unit, wherein said second compute unit is configured to provide a request to store second data into cache of said processor; and
wherein said cache control unit further configured to receive an indication that said second data is non-temporal data in response to said request to store said second data, said cache control unit further configured to select a second predetermined location in said cache to which storage of the second data is restricted.

22. The non-transitory computer-readable medium of claim 20, wherein said cache control unit comprises a replacement algorithm for updating a Least Recently Used (LRU) bit associated with said cache upon storing at least on of said first data or said second data.

23. The non-transitory computer-readable medium of claim 20, wherein said cache control unit being configured to perform at least one of:
associating a marker upon said first data for indicating that said first data is non-temporal data; or
detecting a marker associated with said first data, said marker indicating that said first data is non-temporal data.
